(19) United States
(12) Patent Application Publication
(10) Pub. No.: US 2017/0326513 A1
(43) Pub. Date: Nov. 16, 2017

(54) VORTEX APPARATUS HAVING SLOPED PLATFORM

(71) Applicant: SCIENTIFIC INDUSTRIES, INC., BOHEMIA, NY (US)

(72) Inventor: ROBERT P. NICHOLS, ROCKY POINT, NY (US)

(21) Appl. No.: 15/152,646

(22) Filed: May 12, 2016

(51) Int. Cl. B01F 9/00; B01F 9/10

(52) U.S. Cl. CPC B01F 9/0005; B01F 9/10; B01F 2009/0061

(57) ABSTRACT

An apparatus includes a motor configured to move a platform on a predetermined orbit. The platform is connected to the motor, and the platform is configured to receive one or more vessels. Material included in each of the one or more vessels is mixed when the platform is moved on the predetermined orbit. The platform is sloped down, with respect to a horizontal axis, in a direction from any point along the predetermined orbit toward the center of the orbit.

### TECHNICAL FIELD

The present invention relates to a vortex apparatus, and more particularly, to a vortex apparatus having a sloped platform.

### DISCUSSION OF THE RELATED ART

A vortex apparatus is an apparatus used for mixing fluid and/or solid material. A vortex apparatus may include a platform on which one or more containers may be loaded. The platform and the containers may be referred to as attachments. Each container may include the fluid and/or solid material which needs to be mixed. The platform may be orbited around a predetermined path at a high speed. The orbiting of the platform creates a vortex in the containers. Thus, the contents of each of the containers may be mixed.

Over the years, the power and speed of the vortex apparatuses has increased. In addition, the attachments have become larger and heavier. Due to their increased weight, the attachments wobble during a vortex operation. As a result, a portion of the power expended by the vortex apparatus during a vortex operation is used to wobble the attachments. Thus, a mixing efficiency of the vortex apparatus is reduced and power consumption thereof is increased.

### SUMMARY

According to an exemplary embodiment of the present invention, an apparatus includes a motor configured to move a platform on a predetermined orbit. The platform is connected to the motor, and the platform is configured to receive one or more vessels. Material included in each of the one or more vessels is mixed when the platform is moved on the predetermined orbit. The platform is sloped down, with respect to a horizontal axis, in a direction from any point along the predetermined orbit toward the center of the orbit.

According to an exemplary embodiment of the present invention, a mixing apparatus includes a motor and a platform connected to the motor. The platform is configured to receive a vessel, the vessel including material to be mixed. The motor is configured to move the platform along a predetermined orbit to mix the material included in the vessel. The vessel is sloped with respect to a vertical axis such that the vessel is mirrored about the vertical axis when disposed at diametrically opposite locations along the predetermined orbit.

### BRIEF DESCRIPTION OF THE DRAWINGS

The above and other features and aspects of the present invention will become more apparent by describing in detail exemplary embodiments thereof with reference to the accompanying drawings, in which:

FIG. 1 is a cross-sectional view of a vortex apparatus, according to an exemplary embodiment of the present invention;

FIG. 2 illustrates an enlarged region C of FIG. 1, according to an exemplary embodiment of the present invention; and

FIG. 3 is a cross-sectional view of a vortex apparatus, according to an exemplary embodiment of the present invention.

### DETAILED DESCRIPTION OF THE EMBODIMENTS

Exemplary embodiments of the present invention will now be described more fully hereinafter with reference to the accompanying drawings. The present invention may, however, be embodied in different forms and should not be construed as limited to the embodiments set forth herein. In the drawings, the sizes and relative sizes of elements and regions may be exaggerated for clarity.

It will be understood that when an element is referred to as being “on,” “connected to” or “coupled to” another element, it can be directly on, connected, or coupled to the other element, or intervening elements may be present.

As used herein, the singular forms “a,” “an” and “the” are intended to include the plural forms as well, unless the context clearly indicates otherwise. It will be further understood that terms such as those defined in commonly used dictionaries should be interpreted as having a meaning that is consistent with their meaning in the context of the relevant art and will not be interpreted in an idealized or overly formal sense unless expressly so defined herein.

A vortex apparatus, according to an exemplary embodiment of the present invention, orbits (e.g., moves) a platform on a predetermined orbit to mix fluids and/or solids included in a container. The container is disposed on the platform. The platform does not rotate about itself. For example, as the platform travels on the predetermined orbit, a stationary object that is spaced apart from the vortex apparatus faces a same portion of a vertical exterior surface of the platform.

At any point along its orbit, the platform is tilted toward the center of the orbit. For example, the platform is tilted downward, with respect to a horizontal axis, toward the center of the orbit. In other words, the platform is tilted downward, with respect to the horizontal axis, in a direction starting from any point along the orbit and traveling toward the center of the orbit.

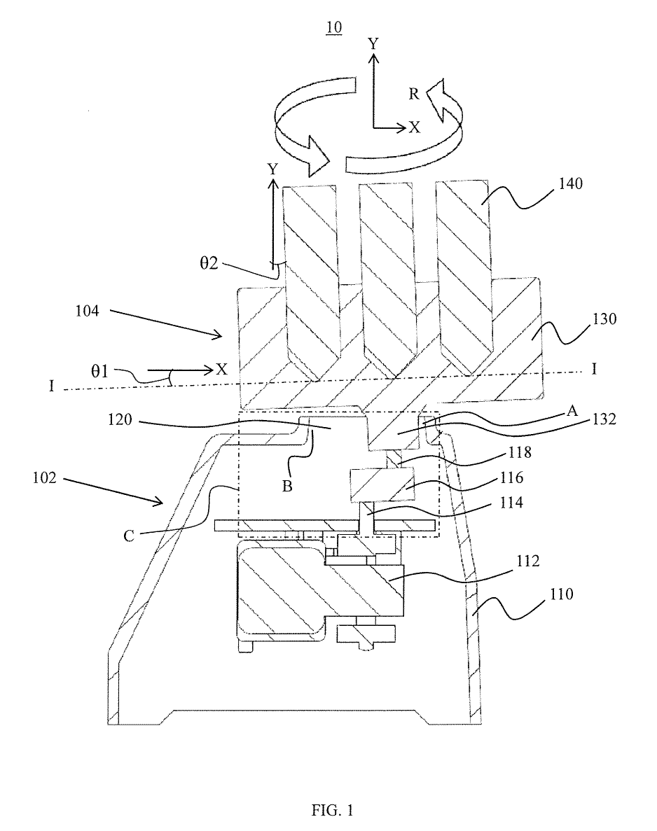

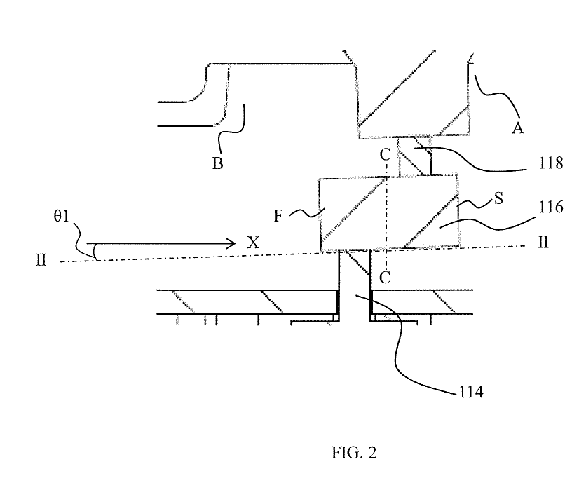

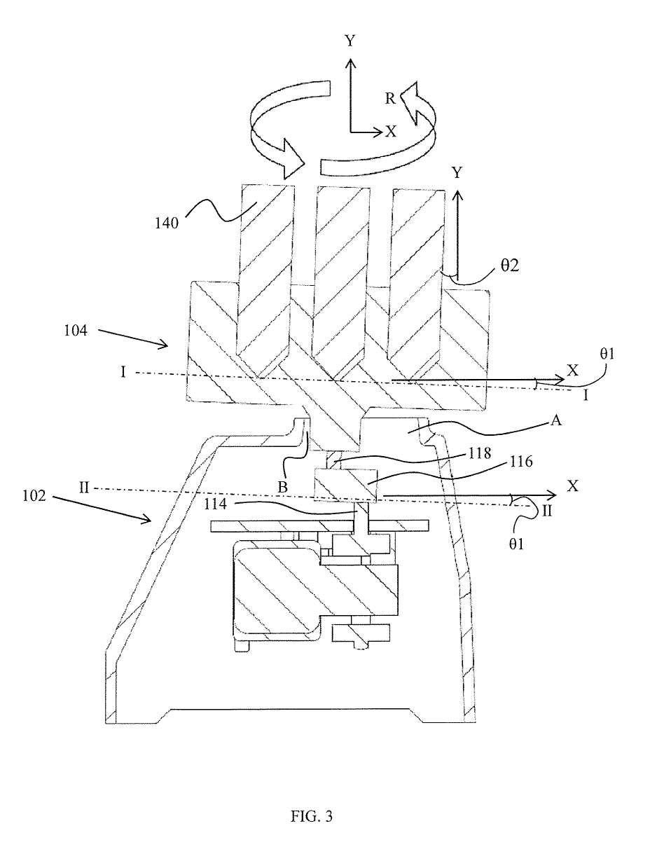

FIG. 1 is a cross-sectional view of a vortex apparatus, according to an exemplary embodiment of the present invention. FIG. 2 illustrates an enlarged region C of FIG. 1, according to an exemplary embodiment of the present invention. FIG. 3 is a cross-sectional view of a vortex apparatus, according to an exemplary embodiment of the present invention.

Referring to FIGS. 1, 2 and 3, a vortex apparatus 10 includes a body 102 and a platform 104. The platform 104 includes a support part 130 and a protrusion 132. One or more containers 140 may be disposed in the support part 130 and fastened to the support part 130. Each of the containers 140 may include a fluid, a solid, and/or a semi-solid for mixing during a vortex operation of the vortex apparatus 10. The solid may be material or elements in solid form, for example, sand, salt, powder material, etc, or a mixture of powered or granular material. The fluid may be gas, liquid, gel, or a mixture thereof. However, it is understood that a fluid does not resist shear stress and that a solid resists shear stress. The semi-solid may include material that includes physical attributes of a solid and a fluid. For example, the semi-solid may resist shear stress in some circumstances and may not resist shear stress in other circumstances. A semi-solid may include, for example, protein-bound iodine.

The vortex operation includes orbiting the platform 104 along an orbit R as shown by two curved arrows in FIG. 1. The orbit R may be a circular path around a vertical axis Y. For example, the orbit R may be a circular path that is parallel to a horizontal axis X. The horizontal axis X extends parallel to a horizontal plane on which the body 102 is supported. The vertical axis Y extends along a direction that is perpendicular to the horizontal axis X. The platform 104 does not rotate around the vertical axis Y when it is orbited on the orbit R. A clamp that may be used to prevent the platform 104 from rotating around the vertical axis Y is omitted from FIGS. 1 to 3 for clarity of illustration.

A vortex may be caused within each of the containers 140 during the vortex operation. For example, the vortex includes a first surface elevation of the fluids and/or solids inside of a container 140 being higher than a second surface elevation of the fluids and/or solids.

The body 102 includes a housing 110, a motor 112, a drive shaft 114, an eccentric 116, and an offset shaft 118.

The motor 112 may rotate the drive shaft 14 about an axis of the drive shaft 14 that extends along the vertical axis Y. The motor 112 causes the platform 104 to orbit along the orbit R by rotating the drive shaft 114. The motor 112 may be connected to a first end of the drive shaft 114 to rotate the drive shaft 114. A second end of the drive shaft 114 may be connected to the eccentric 116.

Referring to FIG. 2, the second end of the drive shaft 114 is connected to a bottom surface of the eccentric 116, between a first end F and a centerline C-C of the eccentric 116. The centerline C-C is an imaginary line that passes through a center of the eccentric 116, and may be parallel to the vertical axis Y. A first end of the offset shaft 118 may be connected to a top surface of the eccentric 116, between a second end S and the centerline C-C of the eccentric 116. The first and second ends F and S may be opposite to each other. In other words, the drive shaft 114 and the offset shaft 118 are spaced apart from each other by a distance along the horizontal axis X.

The first end of the offset shaft 118 may be pivotally connected with the eccentric 116. The second end of the offset shaft 118 may be pivotally connected with the protrusion 132.

FIG. 1 illustrates the vortex apparatus 10 at a state where the protrusion 132 is at a location A of an opening 120 of the housing 110. As described above, the two curved arrows in FIG. 1 illustrate the orbit R of the platform 104. Thus, at location A, the platform 104 is disposed at a first point along the orbit R. The center of the orbit R may correspond to the center of the opening 120. For example, the center of the orbit R may correspond to a region of the opening 120 that is disposed between location A and location B.

Line I-I of FIG. 1 is an imaginary line that illustrates the alignment of the platform 104 with respect to the horizontal axis X. The containers 140 may extend perpendicularly to the line I-I. θ1 is an angle formed between the horizontal axis X and the line I-I. θ1 may be about 1° to about 2°. Accordingly, the containers 140 may form an angle θ2 with respect to the vertical axis Y. θ2 may be equal to θ1 in magnitude. In an exemplary embodiment of the present invention, θ1 is equal to 1.25°.

Referring to FIG. 2, according to an exemplary embodiment of the present invention, the eccentric 116 is sloped with respect to the horizontal axis X by θ1. For example, a line II-II is an imaginary line that illustrates the alignment of the eccentric 116. The line may form the angle θ1 of about 1° to about 2° with the horizontal axis X. As describe above, at location A, the platform 104 is disposed at a first point along the orbit R. Referring to FIGS. 1 and 2, the angle θ1 is formed in a direction from the first point along the orbit R toward the center of the orbit R. For example, when the protrusion 132 is located at location A, the imaginary line I-I, in a direction starting from the first point along the orbit R, toward the center of the orbit R, forms the angle θ1 downward with respect to the horizontal axis X.

Accordingly, the platform 104 forms the angle θ1 downward with respect to the horizontal axis X, in a direction from the first point along the orbit R toward the center of the orbit R, when the protrusion 132 is disposed at the location A. In addition, when the platform 104 is disposed at the first point along the orbit R, each of the containers 140 forms the angle θ2 of about 1° to about 2° with respect to the vertical axis Y, as shown in FIG. 1. In the case when the containers 140 have a varying shape, the angle θ2 is measured against the vertical axis Y with respect to an imaginary line passing through a middle of the varying shape of each of the containers 140.

Referring to FIG. 3, the platform 104 reaches location B of the opening 120 as it travels on the orbit R. At location B, the platform 104 is disposed at a second point along the orbit R. As can be seen in FIG. 3, the eccentric 116 and the platform 104 form the angle θ1 downward with the horizontal axis X. In this case, the angle θ1 is formed in a direction from the second point of the orbit R toward the center of the orbit R. For example, when the protrusion 132 is located at location B, the imaginary lines I-I and II-II, in a direction starting from the second point along the orbit R, toward the center of the orbit R, form the angle θ1 downward with respect to the horizontal axis X.

In addition, in FIG. 3, the containers 140 form the angle θ2 with the vertical axis Y in a direction opposite to that of the containers 140 in FIG. 1. For example, the containers 140 in FIG. 3 lean in a direction opposite to that of the containers 140 in FIG. 1. In other words, each of the platform 104 and the containers 140 lean in opposite directions with respect to the vertical axis Y at diametrically opposite locations along the orbit R. Referring to FIGS. 1 and 3, the arrangement of the eccentric 116, offset shaft 118, platform 104 and containers 140 may be mirrored with respect to the vertical axis Y at diametrically opposite locations along the orbit R.

Accordingly, the platform 104 is sloped downward in a direction from the location along the orbit R in which the platform 104 is located, toward the center of the orbit R. In other words, when the platform 104 is disposed at any point along the orbit R, the platform 104 is sloped downward toward the center of the orbit R from the point along the orbit R in which the platform 104 is disposed.

As a result of the platform 104 and containers 140 being sloped as described above, a wobbling of the platform 104 is reduced during a vortex operation of the vortex apparatus 10. In addition, an efficiency of mixing the fluids, solids, and/or gas included in the containers 140 is increased and a power consumption of the vortex apparatus 10 is decreased.

It is understood that the arrangement of the components of the vortex apparatus 10 may be variously modified without departing from the spirit and scope of the present invention. For example, according to an exemplary embodiment of the present invention, the eccentric 116 may be sloped by an angle greater than or less than θ1, as long as the platform 104 and containers 140 are sloped downward toward the center of the orbit R as described above. In addition, according to an exemplary embodiment of the present invention, the offset shaft 118 may be parallel to the vertical axis Y or may form an angle with the vertical axis Y, as long as the platform 104 and the containers 140 are sloped downward toward the center of the orbit R as described above.

While the present invention has been particularly shown and described with reference to exemplary embodiments thereof, it will be apparent to those of ordinary skill in the art that various changes in form and detail may be made therein without departing from the spirit and scope of the invention as defined by the following claims.

What is claimed is:

1. An apparatus, comprising:
a motor configured to move a platform on a predetermined orbit,
wherein the platform is connected to the motor, and the platform is configured to receive one or more vessels, wherein material included in each of the one or more vessels is mixed when the platform is moved on the predetermined orbit,
wherein the platform is sloped down, with respect to a horizontal axis, in a direction from any point along the predetermined orbit toward the center of the orbit.

2. The apparatus of claim 1, wherein the platform is sloped about 1° to about 2° with respect to the horizontal axis.

3. The apparatus of claim 1, wherein the predetermined orbit is circular.

4. The apparatus of claim 2, wherein the motor is connected to a first shaft, wherein the first shaft is connected to a first surface of an eccentric, wherein a second shaft is connected to a second surface of the eccentric and the platform,
wherein the first shaft and the second shaft are spaced apart from each other along the horizontal axis.

5. The apparatus of claim 4, wherein the eccentric is sloped down, with respect to the horizontal axis, in a direction from any point along the predetermined orbit toward the center of the orbit.

6. The apparatus of claim 5, wherein the eccentric is sloped about 1° to about 2° with respect to the horizontal axis.

7. The apparatus of claim 1, wherein a container disposed on the platform is sloped about 1° to about 2° with respect to a vertical axis, wherein the vertical axis is perpendicular to the horizontal axis.

8. The apparatus of claim 1, wherein the material included in the one or more vessels is a solid or a fluid.

9. A mixing apparatus, comprising:
a motor; and
a platform connected to the motor;
wherein the platform is configured to receive a vessel, the vessel including material to be mixed,
wherein the motor is configured to move the platform along a predetermined orbit to mix the material included in the vessel,
wherein the vessel is sloped with respect to a vertical axis such that the vessel is mirrored about the vertical axis when disposed at diametrically opposite locations along the predetermined orbit.

10. The apparatus of claim 9, wherein the predetermined orbit is a circular path that is parallel to a horizontal plane, and the vertical axis is perpendicular to the horizontal plane.

11. The apparatus of claim 10, wherein the vessel is sloped from about 1° to about 2° with respect to the vertical axis.

12. The apparatus of claim 9, wherein the vessel is configured to be perpendicular to the platform.

13. The apparatus of claim 10, wherein, when a horizontal axis is parallel to the horizontal plane, the platform is sloped down, with respect to the horizontal axis, in a direction from any point along the predetermined orbit toward the center of the orbit.

14. The apparatus of claim 13, wherein the platform is sloped about 1° to about 2° with respect to the horizontal axis.

15. The apparatus of claim 13, further comprising a first shaft, a second shaft, and an eccentric, wherein the first shaft is connected to the motor and to a first surface of an eccentric, and the second shaft is connected to a second surface of the eccentric and to the platform,
wherein the first shaft and the second shaft are spaced apart from each other along the horizontal axis.

16. The apparatus of claim 15, the eccentric is sloped about 1° to about 2° with respect to the horizontal axis.

17. The apparatus of claim 10, wherein the material included in the one or more vessels is a solid or a fluid.
